(19) United States
(12) Patent Application Publication
(10) Pub. No.: US 2022/0297340 A1
(43) Pub. Date: Sep. 22, 2022

(54) A Chainsaw Cutting Link, A Saw Chain, A Method of Manufacturing a Cutting Link, and Use of a Cutting Link

(71) Applicant: HUSQVARNA AB, HUSKVARNA (SE)

(72) Inventors: Per Carlbäck, GRÄNNA (SE); Jonatan Wendel, Jönköping (SE)

(21) Appl. No.: 17/619,621

(22) PCT Filed: Oct. 16, 2020
(86) PCT No.: PCT/SE2020/050989

§ 371 Date: Dec. 16, 2021

(30) Foreign Application Priority Data
Oct. 17, 2019 (SE) 1951176-5

(51) Int. Cl. B27B 33/14; B23D 63/16

(52) U.S. Cl. CPC B27B 33/142; B23D 63/162; B27B 33/141

(57) ABSTRACT

A chainsaw cutting link (1b) comprises a cutting tooth (7b) with a side plate (12b) and a top plate (10b), defining an L-shaped cutting edge (13b, 14b). The top plate (10b) comprises an outer surface (11b) with a first outer surface portion and a depressed second outer surface portion (16). A saw chain comprises a plurality of such cutting links (1b). Use of such cutting links (1b) or such a saw chain increases the ability of making bore cuts. A method of manufacturing a cutting link (1b) comprises: punching a piece of material to form a cutting link (1b) blank with a top plate portion (10b) and a side plate portion (12b); bending the top plate portion (10b) to form an L-shaped cutting edge (13b, 14b); and grinding thereof. An area of the top plate (10b), corresponding to the second outer surface (16) is depressed.

### FIELD OF THE INVENTION

The present invention relates to a chainsaw cutting link comprising a cutting tooth with a side plate and a top plate, defining an L-shaped cutting edge, the top plate comprising an outer surface with a first outer surface portion extending in a first plane at a distance from and facing away from a second plane, which includes two pivot axes defined by two rivet holes of the cutting link,

The invention also relates to a saw chain for a chainsaw.

The invention further relates to a use of a chainsaw cutting link or a saw chain.

The invention also relates to a method of manufacturing a chainsaw cutting link.

### BACKGROUND

Chainsaws are commonly used to cut timber or to perform other rigorous cutting operations. Chainsaws are typically relatively robust hand-held machines which include a housing containing a driving device, e.g. a motor powered by gasoline or an electric motor. A guide bar extends from the housing, and a saw chain is driven by the driving device around the perimeter of the guide bar at a relative high speed. The saw chain may include different types of links arranged in different configurations. Some of the links included in the saw chain may be cutting links having a sharpened portion for cutting through a medium to be cut, e.g. wood.

U.S. Pat. No. 2,774,396 discloses a chainsaw cutting link, which is representative of the prior art.

In certain uses of a chainsaw, there is a need for performing a bore cut, which includes the insertion of the distal end of the guide bar first into a log or the trunk of a tree. The chain revolves around the nose sprocket at the distal end of the guide bar, and a cut with an arcuate profile results.

When performing a bore cut, as well as in other uses of the chainsaw, it is desirable to maximise the performance of the saw chain and its links. The lifetime of the saw chain with a maintained good performance should be as long as possible. Occasionally, the performance worsens as the saw chain undergoes wear and re-grinding.

### SUMMARY

It is desirable to solve, or at least mitigate, the above-mentioned problems. To this end, there is provided a chainsaw cutting link as described in the introduction wherein the outer surface of the top plate is provided with a depressed second outer surface portion at its trailing end. Thereby, the top plate on each cutting link will be less prone to encounter the wood of an arcuate cut, and the cutting edge of the cutting link may freely enter the wood when a bore cut is performed. At the same time, the strength of the cutting tooth is maximized, as the length of the top and side plates are maintained, as seen in the direction of motion of the chain. According to some embodiments, the first plane may be inclined in relation to the direction of motion of the chain. The first plane may also be inclined in relation to the pivot axes.

In some embodiments of the chainsaw cutting link, the L-shaped cutting edge is arranged at a leading end of the first outer surface portion, as seen in the direction of motion. Also, the intended direction of motion is parallel with the second plane and perpendicular to the pivot axes. Thereby, the wood is easily encountered in an arcuate cut, and the strength of the cutting tooth is maximized.

In further embodiments of the chainsaw cutting link, a depth gauge is arranged in front of the L-shaped cutting edge as seen in the direction of motion. Thereby a limit is attained for the thickness of the wood chips that are cut off by the cutting edge.

In some embodiments of the chainsaw cutting link, the depressed second outer surface portion is at least 0.1 mm lower than the than the first plane of the first outer surface portion. Depressions in this magnitude have been shown to be sufficient for providing the desired effect. A suitable degree of depression is determined in part by the diameter of the nose sprocket, with a need for a larger depression with a decreasing diameter of the nose sprocket and vice versa. Also, the total length of the cutting link affects the suitable degree of depression. The smaller the length of the cutting link, the smaller degree of depression will be needed.

In some embodiments of the chainsaw cutting link the depressed second outer surface portion is in the range of 0.3-0.5 mm lower than the first plane of the first outer surface portion. This range provides a particularly good balance between cutting efficiency, mechanical strength, and ease of manufacture, for obtaining the desired effect.

According to some embodiments, the depressed second outer surface portion has an extent, along a projection of the cutting direction/intended direction of motion of the cutting link onto said first plane, of at least 0.5 mm. According to further examples, the depressed second outer surface portion may have an extent along said projection of at least 1 mm, for example between 1 mm and 4 mm.

In some embodiments of the chainsaw cutting link, the second outer surface portion and the first outer surface portion extend in approximately parallel planes. This has the technical effect of providing a cutting link which is easy to manufacture.

In some embodiments of the chainsaw cutting link, the second outer surface is formed by coining of a portion of the top plate. This makes the cutting link simple and inexpensive to manufacture.

In further embodiments of the chainsaw cutting link, the second outer surface is formed by cutting of a portion of the top plate. This makes the cutting link simple and inexpensive to manufacture.

In further embodiments of the chainsaw cutting link, the second outer surface is formed by grinding of a portion of the top plate. This makes the cutting link simple and inexpensive to manufacture.

In still further embodiments of the chainsaw cutting link a forward, slanting border of the depressed second outer surface portion is approximately parallel with the top plate cutting edge. This feature will maximize the area of the first outer surface portion, which is also the area available for providing the top plate cutting edge by grinding and regrinding.

In even further embodiments, the chainsaw cutting link, a rear border of the depressed second outer surface portion is arranged at an angle to the top plate cutting edge. Thereby the section of the top plate will be maximized in the area where it is joined with the side plate.

According to a second aspect of the present disclosure, parts of, or all, the above-mentioned problems are solved, or at least mitigated, by a saw chain for a chainsaw, where the saw chain comprises a plurality of cutting links according to any embodiments as described above.

According to a third aspect, by the use of a chainsaw cutting link or a saw chain as defined above, for increasing the ability of making bore cuts throughout the lifetime of the cutting link, the above-mentioned problems are solved, or at least mitigated.

According to a fourth aspect, there is provided a method of manufacturing a chainsaw cutting link, comprising the steps of:

punching a piece of material to form a cutting link blank comprising a top plate portion and a side plate portion;

bending the top plate portion in relation to the side plate portion to form an L-shaped cutting edge; and

grinding the L-shaped cutting edge;

wherein the method further comprises the step of processing an area of the top plate to form a depressed outer surface portion (16) at a trailing end of the top plate portion (10b). This has the technical effect of providing the chainsaw cutting link as described above.

According to some embodiments of the method, the step of processing an area of the top plate is performed before the step of bending the cutting link blank. This simplifies manufacture.

It is noted that embodiments of the invention may be embodied by all possible combinations of features recited in the claims. Further, it will be appreciated that the various embodiments described for the cutting link are all combinable with the methods and devices as defined.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a side view of a chainsaw including a saw chain;

FIG. 2 is an enlarged view of the front end of the chainsaw;

FIG. 3a is a side view of a first cutting link;

FIG. 3b is a top view of the cutting link according to FIG. 3a;

FIG. 4a is a perspective view of a second cutting link;

FIG. 4b is a top view of the cutting link according to FIG. 4a;

FIG. 5a is a perspective view of a third cutting link;

FIG. 5b is a top view of the cutting link according to FIG. 5a; and

FIG. 6 is a flow chart of the manufacturing method.

All the figures are schematic, not necessarily to scale, and generally only show parts which are necessary in order to elucidate the embodiments, wherein other parts may be omitted.

### DETAILED DESCRIPTION OF THE EXEMPLARY EMBODIMENTS

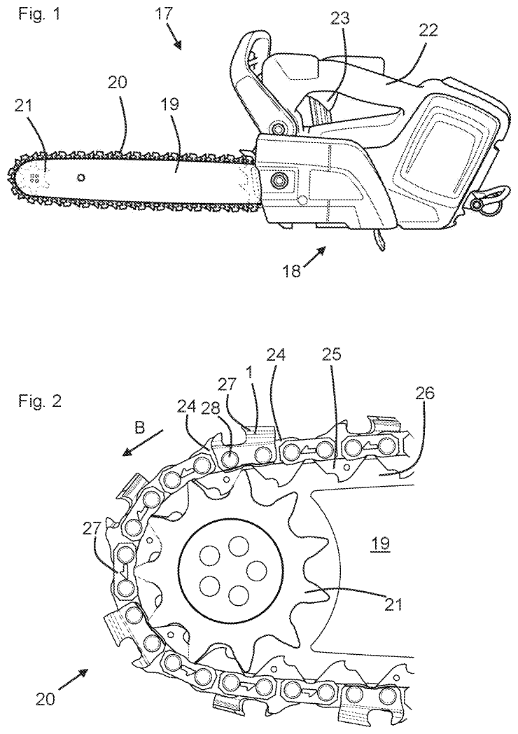

FIG. 1 illustrates a handheld chainsaw 17 comprising a drive unit 18, a guide bar 19 and a saw chain 20 configured as an endless loop, guided along the guide bar 19, between a drive sprocket (not illustrated) and a nose sprocket 21. The drive unit 18 comprises a motor (not illustrated). A handle 22 is provided with a trigger 23 for operating the motor. The saw chain 20 is configured to be driven around the guide bar 19 responsive to operation of the motor to enable the chainsaw 17 to cut lumber or other materials.

FIG. 2 illustrates a portion of the saw chain 20 disposed on the guide bar 19, driven around the nose sprocket 21, as seen in FIG. 1. For clarity of illustration, the assembly is illustrated with a side plate of the guide bar 19 broken away, to illustrate how the saw chain 20 is guided within the guide bar 19. The saw chain 20 comprises a plurality of drive links 24, each of which includes a guide tooth 25 that rides in a channel 26 along a periphery of the guide bar 19 and engages with the teeth of the nose sprocket 21. The leading end, with respect to a direction of motion B of the saw chain 20, of each drive link 24 is pivotally connected to a leading pair of tie links 27, a trailing end of which sandwich the leading end of the drive link 24 between them. The pivotal connection is formed by a rivet 28, which penetrates the tie links 27 and the drive link 24 and defines a pivot axis extending in a direction perpendicular to the direction of motion B of the chain 20 during cutting. Similarly, the trailing end of each drive link 24 is pivotally connected, again via a rivet 28, to a trailing pair of tie links 27, a leading end of which sandwich the trailing end of the drive link 24 between them. The connections between drive links 24 and tie links 27 are repeated in an alternating fashion to complete an endless loop around the guide bar 19. In some pairs of tie links 27, one of the tie links 27 is formed as a cutting link 1. The direction of motion B of the saw chain 20 will, in the following, be referred to as the cutting direction.

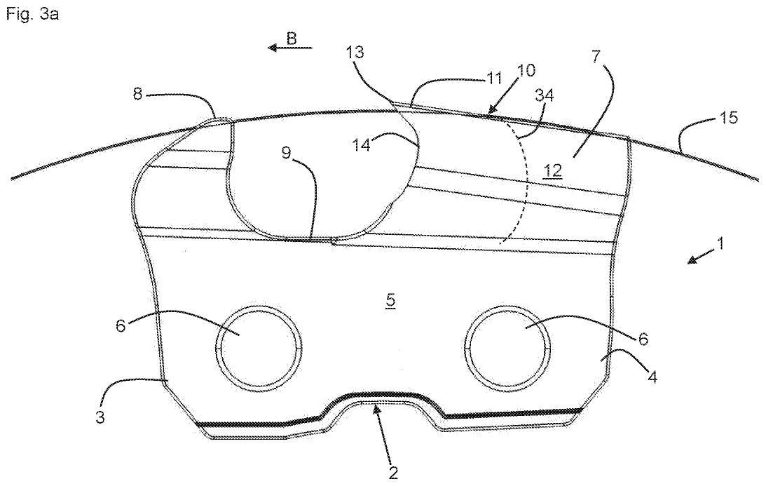

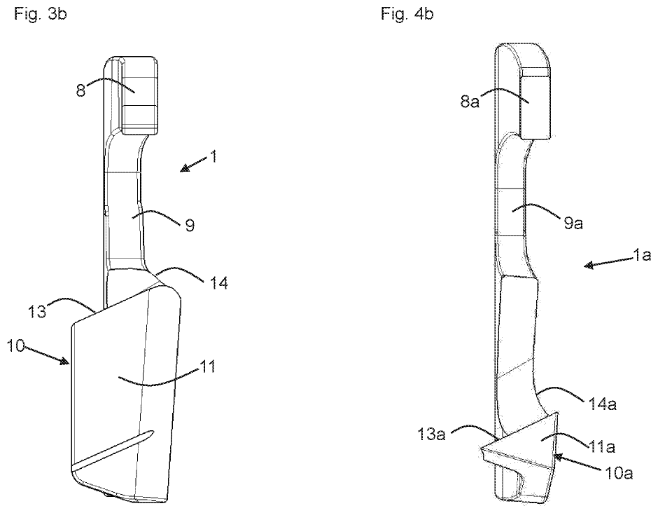

FIG. 3a illustrates a cutting link 1. The cutting link 1 comprises a base portion 2, which is facing the guide bar, when the cutting link 1 forms part of a saw chain, which is mounted on a chainsaw. The cutting link 1 has a leading end 3 and a trailing end 4 as related to a direction of motion B.

The cutting link 1 has two side faces 5, whereof one is visible in FIG. 3a. Through the base portion 2, there are two rivet holes 6, which are used for accommodation of rivets (not shown) connecting the cutting link 1 with adjacent links in a saw chain. A main plane of extension of the cutting link 1 is defined as a plane perpendicular to the rivet holes 6 and the rivets accommodated therein.

A cutting tooth 7 and a depth gauge 8 are arranged at the upper portion of the cutting link 1, separated by a depth gauge gap 9. The depth gauge 8 extends slightly lower than the cutting tooth 7. The difference in height determines the thickness of the wood chips that are shaved off by the cutting link 1 from the wooden object that is cut by the saw chain including the cutting link 1. In FIG. 3a, the depth gauge 8 has a height which corresponds to a newly manufactured cutting link 1, and its height may decrease with wear. Also its height may be reduced intentionally e. g. by grinding.

The cutting tooth 7 comprises a top plate 10 with an outer surface 11, which faces upwards in FIG. 3a, as well as a side plate 12. The top plate 10 and the side plate 12 are arranged at an angle and typically form an L-shape. Both the top plate 10 and the side plate 12 are provided with cutting edges 13, 14, which are best visible in FIG. 3b. The top plate cutting edge 13 is arranged to shave off wood chips, while the side plate cutting edge 14 will cut the wood chips transversally, in order to separate them from the wooden object that is cut.

The cutting links that are disclosed in this application are of a type which receive their cutting edges by grinding and sharpening from below the top plate 10. The front plate receives its sharpened edge from below, and the front plate may be sharpened from the inside of the link, i. e. on the surface that is turned away from the side face 5. The level of the outer surface 11 of the top plate 10 remains unaffected by the grinding throughout the lifetime of the saw chain. This is the case also for the side face 5. The level of the top plate 10 is hence not affected but is determined at the time of manufacture of the link.

The grinding may be performed with a grinding tool that has a circular cross-section, so that the resulting cutting edges will be curved or elliptical, depending on the angle of the grinding tool relative to the cutting link. The grinding tool may be inserted into the cutting link obliquely in such a way that both cutting edges, on the top plate and the side plate respectively, are ground at the same time.

The extension of the depth gauge gap 9 will increase with wear and repeated grinding of the cutting tooth 7. The extension of the depth gauge gap 9 as such will not have any relevant effects on the thickness of the wood chips, but with repeated grindings and a wider depth gauge gap 9, the cutting edge 13 of the top plate 10 will be lower and closer to the back end of the top plate 10.

From time to time, there will be a need to make a bore cut, which includes the insertion of the distal end of the guide bar of the chainsaw first into a log or the trunk of a tree, as discussed in the introduction above. The chain revolves around the nose sprocket 21 at the distal end of the guide bar 19, and a cut with an arcuate profile 15 results. Such a cut 15 is sketched in FIG. 3a. However, the performance of the saw chain 20 may sometimes be limited when performing bore cuts. This is especially the case when the cutting links 1 of the saw chain 20 have been ground several times, and only a limited part of the lifetime of the saw chain 20 remains. A dashed line 34 indicates the position of the cutting edge 14 in such a case. The cutting edge 13 of the top plate 10 will then be reduced to a lower height than shown in FIG. 3a. Also, the depth gauge 8 will be worn or grinded down by the user to compensate for the lowered cutting edge 13 of the top plate 10. The back end of the top plate 10 will in most cases be less worn and has not been subjected to grinding. The back end of the top plate 10 of the cutting link 1, as seen in the direction of movement B of the chain, may then prevent the edge 13 of the top plate 10 from entering the wood in the area of the nose sprocket 21, and the ability to perform a bore cut is partially or completely impaired. This problem becomes more pronounced on chainsaws with small diameter nose sprockets.

Such a case may be deducted from FIG. 3a. When the links of the saw chain have been ground several times, and only a limited part of the lifetime of the chain remains, the top plate cutting edge 13 will be arranged at a greater distance from the depth gauge 8, i. e. the depth gauge gap 9 has increased. The back end of the top plate 10 of the cutting link 1, as seen in the direction of movement, will come into contact with the arcuate wood cut 15, since the arcuate profile 15 has a radius of curvature that is too short to allow the clearance of the back end of the top plate 10, while the top plate cutting edge 13 is able to shave off wood chips. Instead the back end of the top plate 10 will contact the arcuate wood cut, without any contact between the top plate cutting edge 13 and the arcuate cut 15. The top plate cutting edge 13 of the cutting link 1 is hence prevented from entering the wood, since the length of the top plate 10 has been reduced by the grinding, and the top plate cutting edge 13 is now arranged at a lower level than on a new cutting link 1. The problem becomes more pronounced on chainsaws with small diameter nose sprockets, since the radius of curvature of the arcuate cut 15 will be smaller in such cases.

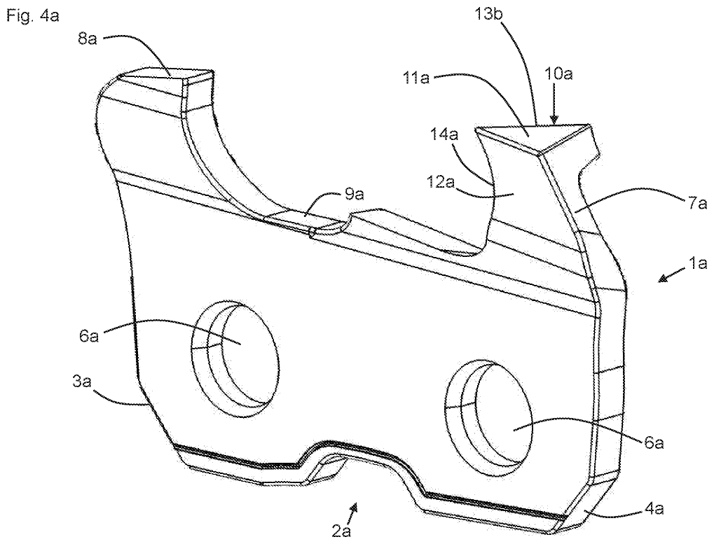

FIGS. 4a and 4b disclose a second cutting link 1a. Similar parts have been given the similar reference numerals as in FIGS. 3a and 3b. In this cutting link 1a, an attempt has been made to overcome the problem, which was outlined above. The cutting tooth 7a and the top plate 10a have been made shorter, as seen in the direction of movement, by removing the trailing end of the top plate 10a. A disadvantage of this attempt is that the strength of the cutting tooth 7a will be reduced, since it is shorter, as seen in the direction of movement. Also, the lifetime of the cutting link la will be reduced, since fewer re-grindings of the cutting edges 13a, 14a will be allowed. Overall, this solution to the above problem is not completely satisfactory.

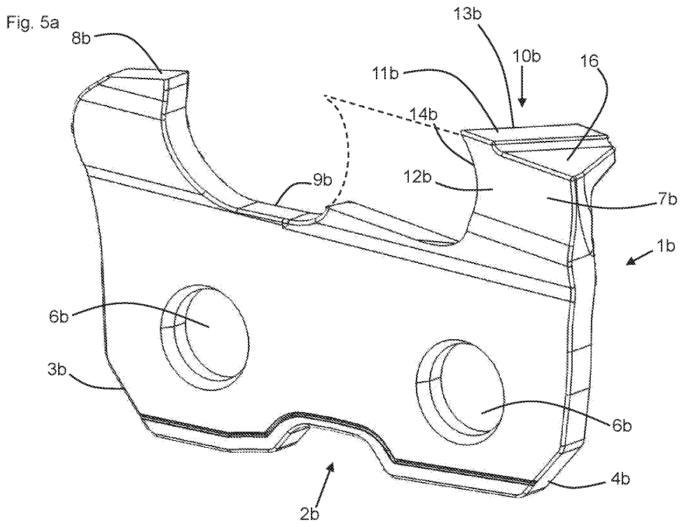

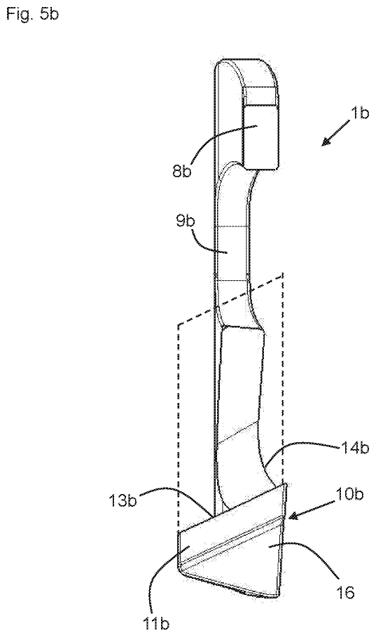

FIGS. 5a and 5b disclose another embodiment of a cutting link 1b, when it has been ground several times. The dashed lines suggest the approximate extension of the cutting tooth 7b and the top plate 10b when the cutting link 1b was new. Similar parts have been given the similar reference numerals as in FIGS. 3a, 3b, 4a, and 4b, respectively. Features disclosed in the embodiments of the previously shown cutting links 1, 1a may be freely combined with one another and also combined with the features of the cutting link 1b.

According to the embodiment shown in FIGS. 5a and 5b, the cutting tooth 7b is provided with a top plate 10b, which comprises a first 11b and a second 16 surface, facing outwards from the cutting link 1b and its main plane of extension, i. e. the first and second surfaces face upwards, as seen in FIGS. 5a and 5b. Both the first and second outer surfaces 11b, 16 are arranged at an angle to the main plane of extension of the cutting link 1b. In the embodiment of FIG. 5a, 5b, the second outer surface 16 extends in a plane which does not coincide with the first plane of the first outer surface 11b at the position of the second surface portion 16. In some other, but not all, embodiments, the second outer surface 16 extends in a plane, which is parallel with the plane of the first outer surface.

In FIGS. 5a and 5b, however, the second outer surface 16 is depressed, and in the illustrated example it extends in a plane which is lower than that of the first outer surface 11b. The distance between the planes of the two surfaces, i. e. the degree of depression is at least 0.1 mm, preferably in the range of 0.3-0.5 mm. Due to the depression of the second outer surface, the trailing end of the top plate 10b is clear of the arcuate wood profile 15b of the bore cut. Hence the top plate cutting edge 13b will be able to contact the wood and shave off a wood chip of the thickness determined by the depth gauge 8b.

It should be noted that the degree of depression needed to obtain the clearance varies with different applications. For example, the smaller, or shorter, the cutting link 1b is, the smaller depression will suffice. On the other hand, the smaller the nose sprocket is, the greater a depression is needed to obtain the clearance of the trailing end. This is due to the fact that a small nose sprocket will create a shorter radius of curvature of the arcuate profile 15b in the wood.

As mentioned earlier above, in connection with FIGS. 3a and 3b, it should be noted that the top plate 10b is sharpened from below. The upper side of the top plate 10b is not submitted to any grinding. The plane of the top plate 10b, i. e. the first plane, may be angled in relation to the second plane. In some embodiments, the angle between the planes is at least 4°, and in some embodiments up to 8° or more. In any case the sharpened cutting edge 13b on the top plate 10b may be accommodated between the first and second planes.

In order to manufacture a cutting link 1b according to the embodiment of FIGS. 5a and 5b, a planar blank is cut or punched 29 from a metal plate of a suitable thickness, i. e. the desired thickness of the finished cutting link 1b. The cutting tooth 7b undergoes one or more bending operations 31 in order to obtain its L-shape, where the top plate 10b faces outwards, away from the base portion 2b of the cutting link 1b. These manufacturing steps coincide with some manufacturing methods of cutting links 1, 1a, according to the prior art.

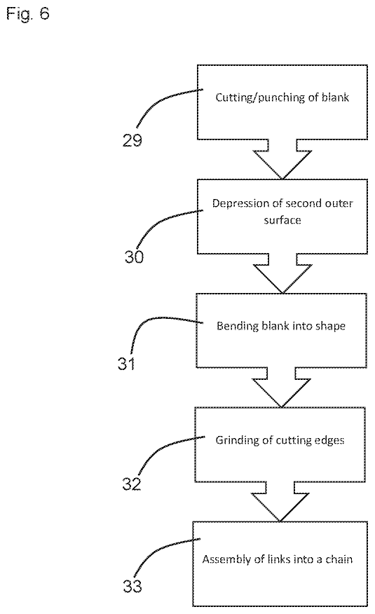

Some embodiments of the manufacturing method of a cutting link 1b according to FIGS. 5a and 5b comprise the step 30 of making the depression of the second outer surface 16 before the bending operation 31. Methods of making the depression 30 include coining, stamping, cutting, striking, as well as grinding the second outer surface 16. When the depression has been made, the cutting tooth 7b may be bent 31 into its final shape by bending operations that are known to the person skilled in the art. Typically a grinding operation 32 from below will take place thereafter in order to provide the top plate cutting edge 13b and the side plate cutting edge 14b, as described above in connection with FIGS. 3a and 3b. A final step of assembly 33 will usually ensue, in order assembly the links into a saw chain 20. The described steps of the manufacturing method are shown in FIG. 6.

The cutting link 1, 1a, 1b has mainly been described above with reference to a few embodiments. However, as is readily appreciated by a person skilled in the art, other embodiments than the ones disclosed above are equally possible within the scope of the invention, as defined by the appended patent claims.

In the claims, the word “comprising” does not exclude other elements or steps, and the indefinite article “a” or “an” does not exclude a plurality.

1. A chainsaw cutting link comprising a cutting tooth with a side plate and a top plate, defining an L-shaped cutting edge, the top plate comprising an outer surface with a first outer surface portion extending in a first plane at a distance from and facing away from a second plane, which includes two pivot axes defined by two rivet holes of the cutting link, wherein the first plane is inclined in relation to the second plane, and wherein the outer surface of the top plate is provided with a depressed second outer surface portion at its a trailing end of the outer surface.

2. The chainsaw cutting link according to claim 1, wherein the L-shaped cutting edge is arranged at a leading end of the first outer surface portion, as seen in an intended direction of motion.

3. The chainsaw cutting link according to claim 2, wherein the intended direction of motion is parallel with the second plane and perpendicular to the pivot axes.

4. The chainsaw cutting link according to claim 1, wherein a depth gauge is arranged in front of the L-shaped cutting edge as seen in the intended direction of motion.

5. The chainsaw cutting link according to claim 1, wherein the depressed second outer surface portion is at least 0.1 mm lower than the first plane of the first outer surface portion.

6. The chainsaw cutting link according to claim 5, wherein the depressed second outer surface portion is in a range of 0.3-0.5 mm lower than the first plane of the first outer surface portion.

7. The chainsaw cutting link according to claim 1, wherein the second outer surface portion and the first outer surface portion extend in approximately parallel planes.

8. The chainsaw cutting link according to claim 1, wherein the second outer surface portion is formed by coining of a portion of the top plate.

9. The chainsaw cutting link according to claim 1, wherein the second outer surface portion is formed by cutting of a portion of the top plate.

10. The chainsaw cutting link according to claim 1, wherein the second outer surface is formed by grinding of a portion of the top plate.

11. The chainsaw cutting link according to claim 1, wherein a leading, slanting border of the depressed second outer surface portion is approximately parallel with the top plate cutting edge.

12. The chainsaw cutting link according to claim 1, wherein a trailing border of the depressed second outer surface portion is arranged at an angle to the top plate cutting edge.

13. A saw chain for a chainsaw, the saw chain comprising a plurality of cutting links according to claim 1.

14. (canceled)

15. A method of manufacturing a chainsaw cutting link, comprising steps of:
punching a piece of material to form a cutting link blank comprising a top plate portion and a side plate portion;
bending the top plate portion in relation to the side plate portion to form an L-shaped cutting edge;
grinding the L-shaped cutting edge; and
processing an area of the top plate portion to form a depressed outer surface portion at a trailing end of the top plate portion.

16. A method according to claim 15, wherein the step of processing the area of the top plate portion is performed before the step of bending the cutting link blank.
